(19) United States
(12) Patent Application Publication
(10) Pub. No.: US 2012/0067548 A1
(43) Pub. Date: Mar. 22, 2012

(54) POLYMERIC MEMBRANE FOR HEAT EXCHANGE APPLICATIONS AND METHOD OF FABRICATION THEREOF

(75) Inventor: Chan Mya Tun, Baulkham Hills (AU)

(73) Assignee: Siemens Industry, Inc., Alpharetta, GA (US)

(21) Appl. No.: 13/235,735

(22) Filed: Sep. 19, 2011

(30) Foreign Application Priority Data
Sep. 20, 2010 (AU) 2010904307

(51) Int. Cl. F28D 15/00; B32B 3/00; B32B 3/26; B29C 47/06; B29C 71/00

(52) U.S. Cl. 165/104.11; 264/129; 428/304.4; 428/220

(57) ABSTRACT

A polymeric membrane for heat exchange comprises a polymeric material and a thermally conductive filler, the polymeric membrane having a thickness in a range of about 50 microns to about 350 microns and a porosity up to about 15 percent.

### CROSS REFERENCE TO RELATED APPLICATION

This application claims the benefit of Australian Provisional Patent Application Serial No. 2010904307, filed 20 Sep. 2010, the entire contents and substance of which is hereby incorporated by reference for all purposes in its entirety.

### FIELD OF THE INVENTION

Embodiments of the present invention relate to polymeric membranes and methods of fabrication thereof, and more particularly to polymeric hollow fibers used in heat exchange applications.

### SUMMARY

Embodiments of the present disclosure relate to a polymeric heat exchange system that shows limited degradation due to chemical and heat exposure, allows only heat transfer without mass transfer, and has the ability to efficiently transfer heat. Aspects of the present disclosure are adapted to overcome or ameliorate at least one of the disadvantages of the prior art, or to provide a useful alternative.

According to one aspect, a polymeric membrane for heat exchange comprises: a non-porous membrane wall; a dense membrane surface structure comprising between 0 to 15% porosity; and a thermally conductive filler, wherein only heat transfer without mass transfer is allowed across the membrane. The polymeric membrane may comprise a thin, dense wall structure to improve the heat transfer. In an exemplary embodiment, the membrane wall is between 50 microns to 350 microns in thickness, more preferably between 100 microns and 250 microns in thickness.

The membrane may be formed from a polymer resistant to degradation by temperatures used in heat exchange applications. In some embodiments, it may be preferred if the polymer is hydrophobic.

The polymer may be selected from a group consisting of PVDF (poly vinylidene fluoride), ECTFE (ethylene-chlorotrifluoroethylene copolymer), ETFE (ethylene trifluoroethylene), PTFE (polytetrafluoroethylene) and FEP (fluorinated ethylene propylene). More preferably the polymer is PVDF (poly vinylidene fluoride) or ECTFE (ethylene-chlorotrifluoroethylene copolymer).

The thermally conductive filler may be micro-dispersed throughout the fiber. It may be in powder form, and may be selected from the group consisting of zinc oxide, titanium dioxide, carbon powder, aluminum nitride, silicon carbide, and boron nitride.

In some embodiments, the thermally conductive filler is carbon powder, particularly nano-scale carbon powder.

In an exemplary embodiment, the membrane is a hollow fiber membrane. The fiber preferably has an outer diameter (OD) of between 0.5 mm and 2.0 mm, more preferably to between 1.0 mm and 1.5 mm.

The fiber may be formed by thermally induced phase separation. The thermally conductive filler is included in dope used to form the hollow fiber.

According to another aspect, the disclosure may relate to a module for use in heat exchange applications comprising polymeric membrane.

According to yet another aspect, a method of manufacturing polymeric hollow fiber for use in heat exchange applications comprises: forming a dope of a polymer, a compatible solvent for the polymer at the manufacturing temperature and a thermally conductive filler; forming the dope into a hollow fiber shape; contacting an external surface of the dope with a coating fluid; contacting an internal lumen surface of the dope with a lumen forming fluid; and thermally inducing phase separation in the dope to form a hollow fiber membrane.

The lumen forming fluid flow rate may be controlled to produce a thin, dense fiber wall with reduced resistance to improve the heat transfer. The fiber comprises a dense fiber surface structure wherein the formation of the dense surface structure is controlled by the coating fluid flow rate.

The hollow fiber may be formed from a polymer resistant to degradation by temperatures used in heat exchange applications. The polymer may be hydrophobic.

The polymer may be selected from a group consisting of PVDF (poly vinylidene fluoride), ECTFE (ethylene-chlorotrifluoroethylene copolymer), ETFE (ethylene trifluoroethylene), PTFE (polytetrafluoroethylene) and PEP (fluorinated ethylene propylene). In some instances, the polymer may be PVDF (poly vinylidene fluoride) or ECTFE (ethylene-chlorotrifluoroethylene copolymer).

The thermally conductive filler may be distributed uniformly throughout the dope. It may be in powder form, and may be selected from the group consisting of zinc oxide, titanium dioxide, carbon powder, aluminum nitride, silicon carbide, and boron nitride.

In some instances, the thermally conductive filler is carbon powder, especially nano-scale carbon powder.

The polymer and the thermally conductive filler constitute the total solids present in the dope; the total solids being present in the dope in an amount ranging from 20 to 50% by weight of the mixture, preferably 25 to 40% by weight of the mixture. In some embodiments, the total solids are present in the dope are in an amount ranging from 30 to 35% by weight of the mixture.

The polymer is present in an amount between 70% to 95% by weight of the total solids, preferably 75% and 85% by weight of the total solids, still more preferably 80% by weight of the total solids.

The lumen forming fluid is, for example, diethylene glycol (digol).

The method may be conducted at a temperature above 200° C. or even above 220° C.

According to another aspect, a polymeric hollow fiber for heat exchange applications is manufactured by a method according to the method of manufacturing polymeric hollow fiber for use in heat exchange applications described herein.

According to some embodiments of the disclosure, a polymeric membrane is provided. The polymeric membrane may comprise a polymeric material and a thermally conductive filler dispersed in the polymeric membrane, the polymeric membrane having a thickness in a range of about 50 microns to about 350 microns and a porosity of up to about 15 percent.

The polymeric membrane may have a thickness in a range of about 100 microns to about 250 microns. In certain examples, the polymeric material may be hydrophobic. The thermally conductive filler may be in a powder form. The thermally conductive filler may be selected from the group consisting of zinc oxide, titanium dioxide, carbon powder, nano-carbon powder, aluminium nitride, silicon carbide, boron nitride, and combinations thereof. The thermally conductive filler is nano-carbon powder. The polymeric membrane may be a hollow fiber membrane. The outer diameter of the hollow fiber membrane may be in a range of about 0.5 mm to about 2.0 mm. The outer diameter of the hollow fiber membrane may be in a range of about 1.0 mm to about 1.5 mm.

The polymeric material of the polymeric membrane may be selected from the group consisting of polyvinylidene fluoride, poly(ethylene chlorotrifluoroethylene), ethylene trifluoroethylene, polytetrafluoroethylene, fluorinated ethylene propylene, and combinations thereof. The polymeric material may be at least one of poly(ethylene chlorotrifluoroethylene) and polyvinylidene fluoride.

In certain examples, the polymeric membrane has a heat transfer coefficient of about 80 W/m²/K to about 95 W/m²/K.

In some embodiments of the disclosure, a method of making a thermally conductive polymeric hollow fiber membrane is provided. The method may comprise preparing a polymer solution comprising a polymeric material and a solvent for the polymeric material at a predetermined temperature. The method may also comprise introducing a thermally conductive filler to the polymer solution to form a dope, and extruding the dope to form the thermally conductive polymeric hollow fiber membrane. Extruding the dope may be accomplished by contacting an external surface of the dope with a coating fluid, contacting an internal lumen surface of the dope with a lumen forming fluid, and inducing a phase separation in the dope to form the thermally conductive polymeric hollow fiber membrane.

In certain embodiments, the dope may comprise a total solids content comprising the polymeric material and the thermally conductive filler. The total solids content of the dope may be in a range of about 20 percent to about 50 percent by weight. In certain examples, the total solids content of the dope may be in a range of about 30 percent to about 35 percent by weight. The total solids content may comprise the polymeric material in an amount in a range of about 70 percent to about 95 percent. The predetermined temperature may be greater than about 200° C. In certain examples, the predetermined temperature may be about 220° C.

The lumen forming fluid may be diethylene glycol. The method may further comprise controlling a flow rate of the lumen forming fluid to form the polymeric hollow fiber membrane. The method may also further comprise controlling a flow rate of the coating fluid to form the polymeric hollow fiber membrane.

In certain embodiments, a heat exchanger system is provided. The heat exchanger system may comprise a membrane module comprising a plurality of hollow fiber polymeric membranes. The plurality of hollow fiber polymeric membranes may comprise a polymeric material and a thermally conductive filler dispersed in the polymeric membrane. The polymeric membrane may have a porosity of up to about 15 percent.

The heat exchanger system may comprise a first manifold fluidly connecting a source of a first fluid to at least one lumen of the plurality of hollow fiber polymeric membranes and a second manifold fluidly connecting a source of a second fluid to a shell surrounding the plurality of hollow fiber membranes. The heat exchanger system may also comprise a first exit port fluidly connected to the source of the first fluid, and a second exit port fluidly connected to the source of the second fluid.

Unless the context clearly requires otherwise, throughout the description and the claims, the words “comprise,” “comprising,” and the like are to be construed in an inclusive sense as opposed to an exclusive or exhaustive sense; that is to say, in the sense of to “including, but not limited to.”

### BRIEF DESCRIPTION OF THE DRAWINGS

The accompanying drawings are not intended to be drawn to scale. Each identical or nearly identical component or feature that is illustrated in various figures is represented by a like numeral. For purposes of clarity, not every component may be labeled in every drawing, nor is every component of each embodiment of the invention shown where illustration is not necessary to allow those of ordinary skill in the art to understand the invention. In the drawings:

FIG. 1 is a diagram of a hollow fiber membrane pertinent to one or more aspects of the disclosure;

FIG. 2a is a diagram of an extruder head suitable for providing the hollow fiber membranes pertinent to one or more aspects of the disclosure;

FIG. 2b is a diagram of an extruder head suitable for providing the hollow fiber membranes pertinent to one or more aspects of the disclosure;

FIG. 3a is a cross-sectional SEM image of a hollow fiber membrane pertinent to one or more aspects of the disclosure made from ethylene-chlorotrifluoroethylene copolymer having a wall thickness of approximately 150 microns, wherein the dense, uniform structure throughout the fiber wall may be designed to achieve heat transfer only;

FIG. 3b is an SEM image of the fiber wall of the hollow fiber of FIG. 3a pertinent to one or more aspects of the disclosure;

FIG. 4 graphically shows the heat exchange in a fiber pertinent to one or more aspects of the disclosure;

FIG. 5 depicts a shell-and-tube cross-flow heat exchanger pertinent to one or more aspects of the disclosure;

FIG. 6 shows the thermal conductivity of a fiber pertinent to one or more aspects of the disclosure with filler powder relative to a polymeric fiber without filler powder, as measured using a Light Flash Analyzer (NETZSCH LFA NanoFlash™ 447).

FIG. 7 shows how fibers pertinent to one or more aspects of the present disclosure may be employed in heat exchangers.

### DETAILED DESCRIPTION

Polymeric materials may be used for filtration devices in a variety of separation applications including desalination, gas separation, filtration, and dialysis. Some separation applications may involve the use of large quantities of heat to induce a phase change in order to separate the components. The properties of polymeric materials, such as chemical resistance and heat resistance, may render them appropriate for heat exchange applications including desalination and membrane distillation.

The properties of polymeric materials present a number of advantages over materials such as metals, which are typically used in the construction of heat exchange systems. Large-scale conventional metal heat exchange systems, such as those used for desalination processes, require substantial capital investment. These systems also have a relatively large footprint and considerable weight, requiring the construction of suitable foundations. Metal heat exchange systems are routinely exposed to harsh chemical solutions that may cause corrosion and the effects are accelerated due to the high temperatures involved. For example, the use of hot brine in desalination processes may lead to rapid and extensive corrosion of metal heat exchangers and the waste brine from the desalination process may become contaminated with heavy metal at an early stage in the life of the apparatus.

Polymeric heat exchange systems are generally constructed at a lower cost than corresponding metal heat exchange systems, are often easier to fabricate, and have a lower weight, thus being more readily movable. Typically, polymeric materials have superior chemical resistance to solvents, acids, oxidizing/reducing agents, and the like when compared to metals used in heat exchange applications. Further, the fabrication of polymeric heat exchange systems requires a lower energy input than the fabrication of metal heat exchange systems.

In spite of these advantages, the use of polymeric materials in heat exchange applications may present many problems. One significant such problem is the low thermal conductivity shown by polymeric materials in comparison to metals. High thermal conductivity is important in ensuring the rapid and efficient transfer of heat in heat exchangers. Using materials with poor conductivity significantly reduces the applicability of polymeric materials for use in heat exchange systems. Unfilled thermoplastics typically have a thermal conductivity of between approximately 0.1 and 0.5 W/m·K (Watts/meter-[degrees]Kelvin). For metals, the conductivities are approximately 16 to 19 W/m·K for stainless steel, approximately 60 to 80 W/m·K for iron, approximately 250 W/m·K for aluminium, and approximately 400 W/m·K for copper. For this reason, the industrial use of polymeric heat exchangers has to date been limited.

U.S. Pat. No. 3,435,893 discloses a heat exchanger component design formed with flexible plastic tubes. A tight enclosure around a plurality of tube elements is described wherein heat and reduced pressure are applied to the tubes to physically unite them. The interior of each tube element communicates with passageways that interact with walls of the structure to form multi-layer arrangements. Although this structure was designed for the concept of heat exchange, the poor conductivity of the flexible plastic tube material was not addressed.

U.S. Pat. No. 4,735,261 discloses an air-to-air polymeric heat exchanger design having a housing and a removably mounted core within the housing. The core includes a pair of end walls and a plurality of plastic tubes extending therebetween. The ends of the tubes are fused within the end walls and the interior of the tubes is exposed through the end walls. Such heat exchangers are specifically designed only for an “air-to-air” heat exchange, where high thermal conductivity is not so critical.

A polymeric film compact heat exchanger design has been investigated by Zaheed et al. in “Review of polymer compact heat exchangers, with special emphasis on a polymer film unit” (Journal of Applied Thermal Engineering 24 (2004) 2323-2358). This design was introduced in an attempt to address the disadvantages of both metallic and existing polymeric heat exchangers. Notable design aspects of the polymer film unit are the use of thin (approximately 100 μm) polymer films to address the thermal conductivity deficiency and the adoption of laminar flows to address the high pressure drops. Corrugations were also used on the films to promote better fluid mixing, which increases the thermal performance of the unit. Poly ether ether ketone (PEEK) was used due to its relatively high thermal, chemical, and mechanical stability. But while thin film technology may be suitable for small scale heat exchange applications, such as in the computer or electronics industry, this technology is not feasible for large scale, industrial heat exchange applications, both in terms of cost and durability.

U.S. Patent Application Publication No. 2007/0107884 to Sirkar et al. (“Sirkar”) discloses a polymeric hollow fiber heat exchange system based upon asymmetric polymeric hollow fibers with a microporous substructure and a dense skin on the fiber surface. This fiber structure may prevent liquid transmission through the wall of the hollow fiber while simultaneously enhancing heat transfer due to the presence of liquid molecules within the to porous substructure of the hollow fiber. But water (along with most other common membrane forming fluids) has a thermal conductivity of about only 0.6 W/m·K, so it is difficult to envisage that the overall conductivity of Sirkar could significantly exceed that figure.

Polymeric heat exchangers using temperature resistant and chemical resistant polymers are also known. Fluorinated polymers such as polytetrafluoroethylene (PTFE), fluorinated ethylene propylene (FEP), polyvinylidene difluoride (PVDF), and ethylene chlorotrifluoroethylene (ECTFE) are known for their superior chemical and heat resistance, when compared to polyolefins such as polypropylene. In spite of their good chemical and heat resistance, fluorinated polymers maintain poor thermal conductivity. PVDF, for example, has a thermal conductivity value of between 0.1 and 0.2 W/m·K. In S. R. Wharry, Jr.'s article entitled “FLUOROPOLYMER HEAT EXCHANGERS” (Metal Finishing, Volume 99, Supplement 1, January 2001, Pages 760-77) (“Wharry”), it is noted that, in order to match the performance of a metal heat exchanger, a fluoropolymer heat exchanger must present more surface area over which the heat exchange process takes place. One way to achieve this in a tube based heat exchanger system is to use a higher number of smaller diameter tubes. Wharry describes that it is difficult to gain heat transfer efficiency with tubing greater than one-half (½) inch (˜1.27 cm). Wharry further describes the use of FEP and ‘Q’ fluoropolymer tubing used in immersion coils that are one-tenth ( 1/10) inch (˜2.5 mm) and one-eighth (⅛) inch (˜3.2 mm) in diameter. But Wharry also discloses that while smaller diameter tubes have significantly higher wall conductivity and thus create a more thermally efficient unit, the smaller diameter tubes are generally suitable only for clean fluids inside the tubes, such as clean steam or cooling water. In this case, the thermal efficiency is limited by the size of the tube suitable for the particular application.

Embodiments of the present disclosure relate to polymeric membranes, for example polymeric hollow fiber membranes, that may be used for heat exchange, and may be suitable for use in applications such as desalination and membrane distillation. The examples described are exemplary embodiments of the disclosure, and the disclosure is not limited to such examples.

The polymeric membranes of the present disclosure may provide for a non-corrosive or corrosion resistant membrane material. The polymeric membranes may be resistant to chemicals, and may be used for a wide range of pH, including alkali and acidic exposure. The polymeric membranes of the present disclosure may provide for a thermally conductive to membrane, and may be thermally stable. Typically, the upper temperature limit at which the membranes may remain stable may be based on the melting point and glass transition temperature of the polymeric material used to make the membranes. For example, the polymeric membranes may be thermally stable at temperatures in a range of about 5° C. to about 140° C. In certain examples, the thermally stability may be greater than 140° C. The stability of the membranes may make them suitable for various applications, including use in the food or pharmaceutical industry.

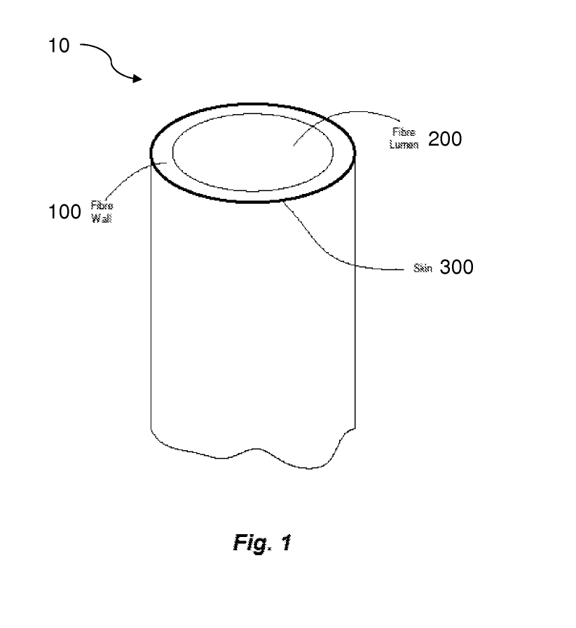

The terminology used herein is generally illustrated in FIG. 1. Elongate hollow fibers 10 have an annular wall 100 surrounding a lumen 200. The wall 100 may optionally have a “skin” 300 of particularly dense or hard material surrounding the wall. The skin 300, if present, may be present on the outward face of the wall 100, on the lumen face of the wall or both.

A dense material is one in which the material is non-porous, or in which the material has a porosity of 15 percent or less. The membrane structure of a dense material may be in a rubbery or a glassy state at a given temperature, depending on its glass transition temperature. The porosity may be in a range of greater than about 0 percent up to about 15 percent. In certain examples, the porosity may be in the range of about 1 percent to about 12 percent. In other examples, the porosity may be in the range of about 2 percent to about 10 percent. In particular examples, the porosity may be in the range of about 2 percent to about 5 percent. In other particular examples, the porosity may be about 5.2 percent. In yet other particular examples, the porosity may be about 2 percent.

A porosity of the polymeric membrane may be selected to provide suitable heat exchange between the sides of the membrane without allowing mass transfer. Mass transfer may typically comprise vapor or volatile components that may pass through the pores of the membrane.

The polymer used to make the hollow fiber in certain aspects of the present disclosure may be suitable for use in a heat exchange application. The polymer may be resistant to degradation at the high temperatures that may be used in such applications. The polymers may also be resistant to attack or degradation by chemicals. Polymers for the hollow fiber in certain aspects of the present disclosure may be selected from the group consisting of PVDF (poly vinylidene fluoride), ECTFE (ethylene-chlorotrifluoroethylene copolymer), ETFE (ethylene trifluoroethylene), PTFE (polytetrafluoroethylene), FEP (fluorinated ethylene propylene), combinations thereof, and the like.

In some embodiments, a polymer may be used to make the heat exchange hollow fibers of certain aspects of the present disclosure may be ethylene-chlorotrifluoroethylene (ECTFE). ECTFE has been surprisingly found to be suitable for heat exchange applications, such as membrane distillation, in spite of the fact that it is only a partially fluorinated polymer. Partially fluorinated polymers are known to have restricted upper operating limits at higher temperature in comparison to fully fluorinated polymers. The melting point of ECTFE is 240° C.

The hollow fiber may be made from ethylene-chlorotrifluoroethylene using the thermally induced phase separation (“TIPS”) process disclosed in the applicant's earlier publications—International (PCT) Patent Application Publication Nos. WO2003/068374 and WO91/17204, each of which is incorporated herein by reference in its entirety for all purposes. The TIPS process may be used to produce an extruded polymer hollow fiber with a relatively high melting point. Polymers that have a relatively high melting point typically do not readily dissolve in a solvent at room temperature or a lower temperature. A polymer having a relatively high melting point may be a polymer that melts at a temperature of greater than 100° C.

The TIPS process may involve dissolving a thermoplastic polymer in a solvent that will dissolve the polymer at an elevated temperature but will not do so at lower temperatures, for example, room temperature. Such a solvent is often called a latent solvent for the polymer. The dope solution of polymer in heated latent solvent is often referred to as the polymer dope. Phase separation of the polymer from the latent solvent may take place at a specific temperature which also depends upon the rate of cooling. The dope concentration and cooling conditions may be controlled to determine whether the precipitated material is porous or non-porous. Upon cooling the dope solution, two liquid phases may be formed, including a polymer rich phase and a solvent rich phase. After the polymer is solidified by crystallization or glass transition, the solvent is removed.

In certain embodiments of the present disclosure, a polymeric material may be used to form the hollow fiber membrane. The polymeric material may be dissolved in a suitable solvent at a predetermined temperature to form a dope. One or more solvents may be used, in a solvent system, to dissolve the polymeric material. In some embodiments the polymeric material may be dissolved in a suitable solvent at a predetermined temperature to provide an optically clear solution that is the dope. The optically clear solution may be a homogeneous dope solution or a visually homogeneous dope solution. Suitable solvents for the polymeric material may include glycerol triacetate or citric acid ethyl ester.

In certain embodiments of the present disclosure, the polymeric material that is used to form the hollow fiber membrane may be poly (ethylene chlorotrifluoroethylene). The poly (ethylene chlorotrifluoroethylene) may be dissolved in a suitable solvent at temperatures above 200° C. to provide a dope. The dope may be an optically clear solution. A suitable solvent that may be used to dissolve poly(ethylene chlorotrifluoroethylene) may be glycerol triacetate or citric acid ethyl ester.

The filler may be any material and any size and shape that is suitable to improve the thermal conductivity of the polymeric material. The filler may be submicron solid inclusions capable of altering the physical and chemical properties of materials through their own physical characteristics or through their interaction with their host substrate, such as the polymeric material. The filler may also impart mechanical reinforcement to the polymeric material. Fillers that may be effective in enhancing thermal conductivity of a polymeric material may be selected from the group consisting of zinc oxide, titanium dioxide, carbon powder, nano-carbon powder, aluminum nitride, silicon carbide, boron nitride, combinations thereof, and the like.

In certain embodiments, the filler may be in the form of a powder. The nano-sized carbon powder is surprisingly effective at improving the thermal conductivity properties of the fiber in spite of its relatively modest thermal conductivity (graphite has a thermal conductivity of about 120-165 W/m·K). Nano-sized carbon powder has also been found to distribute uniformly through the polymer dope upon regular mixing. Other grades of carbon powder may be used, such as normal carbon black and ultra conductive carbon powder, and may be effective in achieving certain aspects of the disclosure. Carbon black is a fluffy powder of extreme fineness and high surface area, composed of elemental carbon with well-developed graphite platelets.

The selected filler may be selected to provide suitable melt flow properties, so as to be adapted to result in a visually homogeneous dope, wherein the filler is thoroughly mixed or dispersed with the polymer dope solution. Typically, no phase separation occurs in the visually homogeneous dope. The resultant mixture may be microscopically or chemically heterogeneous, or colloidal heterogeneous, in which the filler does not settle or separate out from the polymer dope once it is blended or mixed with a homogeneous polymer dope solution. Typically, the filler is not chemically bonded with the polymer in the colloidal to heterogeneous solution. Typically, the filler is of a particular particle size so that when added to the polymer dope solution, it disperses homogeneously throughout the polymer dope and creates a visually homogeneous dope solution. The filler may not be dissolved in the polymer dope solution, but may be physically combined due to the melt flow properties.

The visually homogeneous dope may permit improved uniformity, compatibility, and processing of the polymer dope. Other thermally conductive materials available in nano-dimensions, such as titanium powder and carbon nanotubes, may be used.

As noted by Bhardwaj et al. (Polysulfone Hollow Fiber Gas Separation Membranes filled with submicron particles; Annals of the New York Academy of Sciences; Volume 984, ADVANCED MEMBRANE TECHNOLOGY, Pages 318-328, March 2003), achieving good dispersion of the filler throughout the polymer dope may be difficult to achieve. This may be due to the formation of filler aggregates in the dope and randomly entangled characteristics of some filler compounds. Further, adsorbed water may create polar, high-energy OH groups on the filler molecules, which favors filler-filler interaction and limits the interaction of polymer molecules with the filler molecules, which may create a dispersion. In certain embodiments, the thermally conductive filler powder may have a particle size in a range of about 1 nm to about 100 nm. The thermally conductive filler may have an NSA value in a range of about 1 m²/g to about 100 m²/g. The 500 mesh residue is preferably lower than 0.001%. This level of purity may be used to minimize contamination and influence of the contaminant on the thermal conductivity and melt properties of the filler.

The amount of filler to improve thermal conductivity relative to the polymer may vary depending upon the specific fillers, the nature of the latent solvent, and the desired properties of the filler material.

The filler may be introduced to the dope containing the polymeric material and the solvent or solvent system. In certain embodiments, the filler is carbon powder. The filler may be uniformly distributed throughout the dope mixture.

The thermally conductive filler may be micro-dispersed throughout the fiber. The micro-dispersed filler may be easy to disperse or blend into a polymer dope solution. This may be due to the particle size range of the filler. For example, the particle size range of the filler may be on the scale of micrometers (10⁻⁶ meters) to nanometers (10⁻⁹ meters) in diameter. In certain examples the 35 Mesh residue may be 0.0000, and the 500 Mesh residue may be less than 0.0005.

The thermally conductive filler may reduce or prevent the formation of pores on at least one of the surfaces and throughout the polymeric membrane.

The upper limit to the amount of filler added to the dope may be dictated by the limits on workability and on the mechanical properties of the membrane. For example, the amount of filler that may be added to the dope may be dependent on a predetermined viscosity of the dope that allows for suitable conditions for extrusion of the material. For example, the amount of filler that may be added may affect the flow of the dope during spinning, or during fiber formation. The amount of filler may be selected to prevent breakage during fiber formation. The amount of filler may also be selected to prevent clogging or fouling of the equipment utilized in fiber formation.

The lower limit to the amount of filler added to the dope may be dictated by the desired fiber morphology, or the workability of the dope solution in the extrusion equipment. Additionally, a suitable amount of filler may be added to provide a membrane comprising a suitable thermal conductivity and heat transfer efficiency.

Typically, about 5 weight percent to about 40 weight percent of filler is used (relative to the amount of polymer plus filler). In certain embodiments, about 10 weight percent to about 25 weight percent may be used. In certain other embodiments, about 20 weight percent of carbon powder may be used.

In some embodiments, about 30 weight percent to about 40 weight percent of polymer and filler are used with about 60 weight percent to about 70 weight percent of latent solvent to prepare the polymer dope. For example, a dope prepared according to some embodiments of the disclosure may comprise about 70 weight percent latent solvent, about 24 weight percent ECTFE, and about 6 percent nano-sized carbon powder. In certain embodiments, up to 50 weight percent of polymer may be used.

The viscosity of the visually homogeneous or chemically heterogeneous or colloidal heterogeneous polymer dope solution may be controlled to achieve uniformity and improved dispersion of the filler through the fiber as well as the desired mechanical strength of the final fiber product. The viscosity of a polymer solution depends on concentration and size (molecular weight) of the dissolved polymer. The melt viscosity of a polymer solution in melt processing technology may determine whether a polymer will be melt-processable under any given set of conditions.

In a spinning process according to some embodiments of the disclosure used to produce a fiber, the dope fluid viscosity may be sufficient to maintain the continuous flow of to hollow fiber production. The viscosity of a polymer solution ('η) is related to the molecular weight (MW) of the raw polymer according to the following equation:

η=MW^{3.4}

The molecular weight of the polymer may be used to determine the final properties of melt processing fibers. Based on the same polymer concentration and under the same conditions, a dope fluid prepared from a polymer with a lower molecular weight will have a lower viscosity than a dope fluid prepared from a polymer with a higher molecular weight. It is noted that cooling increases the viscosity of the polymer solution. The viscosity of the dope fluid used to prepare the fibers may be controlled by using a selection of polymer with a predetermined concentration of dope fluid.

A polymer having a higher molecular weight may provide a dope solution having a relatively higher viscosity. Consequently, the dope solution may have a lower melt flow index at its melting point. A dope solution made from a polymer having a lower molecular weight may have a relatively lower viscosity and a greater melt flow index. In embodiments of the present disclosure, the melt flow index at the melting point of the polymer resin may be in a range of from about 1 g/10 min to about 100 g/10 min.

In some embodiments of the disclosure, a separate feeding tank may be used to hold the filler. The polymer dope may be introduced into the extruder and the filler may then be fed into the extruder by a tank, such as a gravimetric feeding tank, for incorporation into the polymer dope. The mass flow of both components may be controlled by means of a PLC program to achieve the required ratio of components according to the disclosure.

The resultant visually homogeneous or chemically heterogeneous or colloidal heterogeneous dope solution is then passed through an annular co-extrusion head. The colloidal heterogeneous dope solution may be a microscopically colloidal heterogeneous dope solution.

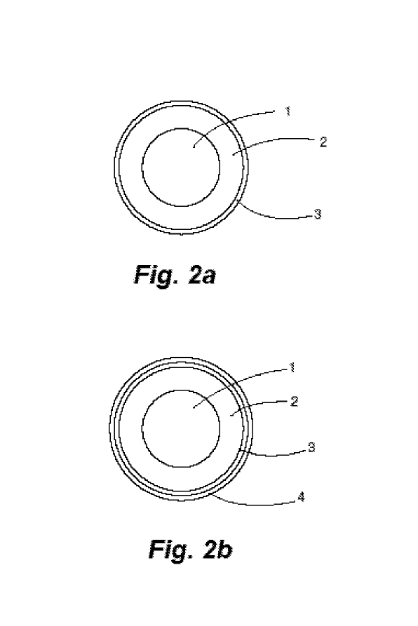

The hollow fiber membranes may be produced by several techniques. In certain embodiments, a triple co-extrusion head having three concentric passageways may be used. In other embodiments, a quadruple co-extrusion head having four concentric passageways may be used. FIGS. 2a and 2b show the types of extrusion head that are suitable for forming the hollow fibers of the present disclosure.

In use of the triple or the quadruple co-extrusion head, a lumen forming fluid is introduced into axial passageway 1. A first outwardly concentric passageway 2 contains a to mixture of the polymer, the filler for improving thermal conductivity and a latent solvent system to form the fiber. The next outwardly concentric passageway 3 contains a coating fluid. In the case of the triple extrusion head, as shown in FIG. 2a, the quench is a bath either directly adjacent the extrusion head or slightly spaced below it with an intermediate air gap. In the quadruple extrusion head shown in FIG. 2b, the outermost passageway 4 applies a quench fluid directly to the surface of the fiber.

Under carefully thermally controlled conditions, the lumen forming fluid, the fiber forming solution, and the coating fluid are contacted with a quench fluid at a predetermined temperature (and flow rate, if the quench is applied by means of an outermost concentric passageway). The fiber forming mixture may come into contact with the lumen forming fluid on the inside of the hollow fiber and with the coating fluid and/or quench bath fluid on the outside of the hollow fiber.

The lumen and coating fluids may contain a variety of solvents chosen as required providing the desired fiber properties. The composition of the coating and lumen fluids may determine the pore size, if any, and frequency throughout the fiber, as well as the thickness of any skin on the surface of the fiber.

Each fluid may be transported to the extrusion head by means of individual metering pumps. The three components may be individually heated and may be transported along thermally insulated and heat traced pipes. The extrusion head may have a number of temperature zones. The lumen fluid, fiber forming solution (dope), and coating fluid may be brought to substantially the same temperature in a closely monitored temperature zone where the dope is shaped. As mentioned above, the exact nature of the quench depends on whether the quadruple or triple extrusion head is used. In the quadruple, the quench fluid is introduced by way of an outer concentric passageway 4. The fiber may travel down the quench tube at a significantly different linear speed from the quench fluid. The fiber may then pass into a further quantity of quenching fluid if desired.

In the triple extruder system, the fiber may pass out of the die, which may optionally be stemmed to assist in determining fiber structure. The fiber may pass through an optional air gap before passing into a quench bath.

When the quench fluid is contacted with the dope, the dope may undergo non-equilibrium liquid-liquid phase separation to form a bicontinuous matrix of large interfacial area of two liquids in which the polymer rich phase is solidified before aggregated separation into distinct phases of small interfacial area may take place. The conditions may be chosen by those skilled in the art to produce either a microporous or non-porous material.

The hollow fiber membrane may leave the extrusion head completely formed and there may be no need for any further formation treatment except for removing the solvent system from the membrane in a post-extrusion operation. An appropriate solvent that does not dissolve the polymer but is miscible with the dope solvents may be used to remove the solvent system for the polymer from the finished membrane.

The lumen forming fluid may be selected from a wide variety of substances. In certain embodiments, the same substance may be used as the coating and quenching liquids. Water or virtually any other liquid may be used as the quench liquid. As was noted in an earlier application, WO2003/068374, which is incorporated herein by reference in its entirety for all purposes, water is used if a highly asymmetric structure is desired.

In order to achieve good conduction of heat transfer through the fiber wall between two fluid streams (liquid/liquid, liquid/gas, or gas/gas), the hollow fiber may be extruded with a relatively thin but dense wall structure. In certain embodiments the wall is about 100 μm to about 250 μm in thickness.

In certain embodiments, if the wall is greater than a predetermined thickness, the fiber resistance for heat transfer will be at a level that may result in poor or unsuitable heat transfer efficiency, which may decrease the overall heat transfer coefficient to an unsuitable level. If the wall is less than a predetermined thickness, the fiber walls may be too thin, resulting in poor operating pressure resistance.

In certain embodiments, the diameter of a hollow fiber membrane may be selected to provide adequate packing density of the fibers and effective heat exchange. In certain embodiments of the disclosure, the surface area of polymeric hollow fiber membranes utilized in a heat exchanger may be greater than the surface area of a metal based heat exchanger. A greater surface area may be obtained by decreasing the diameter of the hollow fiber membranes utilized in the heat exchanger. In contrast, if the fiber diameter is reduced below a predetermined level, the pressure decrease across the module may not be suitable. In certain examples, the fiber may have an outer diameter (OD) in the range of 0.5 mm and 2.0 mm. In certain other examples, the fiber may have an outer diameter in a range of 1.0 mm and 1.5 mm.

To prevent water passage through the hollow fiber, a continuous surface structure may be used, in addition to the uniform, dense structure of the wall.

Manufacture of hollow fibers using a thermally induced phase separation (TIPS) process may not require a non-solvent in the lumen of the fiber for the phase inversion process. Such a non-solvent may be required in a diffusion induced phase separation (DIPS) process. During spinning, solvents may be used on both the outer surface and the lumen of the fiber in the TIPS process. This may enable a smoother fiber surface and a more controlled, porous structure in the fiber to be achieved. As disclosed in U.S. Pat. No. 7,247,238, incorporated herein by reference in its entirety for all purposes, the porosity of a hollow fiber membrane surface may be controlled by adjusting the coating fluid flow rate and through use of different coating fluids. For example, the flow rate of the coating fluid may be between about 1 ml/min and about 10 ml/min, and adjusted accordingly. The coating fluid used may be triethyl citrate, if a more porous surface is desired. Glycerol triacetate may also be used as a coating fluid to provide a less porous surface. In order to obtain the continuous surface structure required by the fibers of the present disclosure, it was found that little to no coating fluid may be applied to the fiber surface during extrusion using the TIPS process. To obtain the thin, dense structure of the fiber wall, the flow rate of the lumen side solvent may be adjusted accordingly. The thin dimension of the dense wall structure of the fiber may be designed to reduce the resistance provided by the membrane fiber wall to encourage heat transfer through the fiber.

The hollow fibers thus produced in certain embodiments of the disclosure may be amenable to use in heat transfer applications. The filler, such as carbon powder, may be retained in the fiber while overall the fiber may retain sufficient mechanical properties and chemical properties. ECTFE is strongly hydrophobic and it therefore repels water penetration and degradation by aqueous species.

### EXAMPLES

### Example 1

A polymeric hollow fiber was prepared. Ethylene-chlorotrifluoroethylene copolymer was used as the polymeric material. The polymeric material was dissolved in a suitable solvent to form a dope solution at a temperature above 200° C. A graphite carbon filler was added to the dope solution and thoroughly mixed, resulting in a dope solution comprising 35 percent by weight of polymer and filler, and 65 percent by weight of solvent. The hollow fiber was extruded at a temperature of 220° C. The polymer to filler ratio by weight of the fiber was 80 to 20.

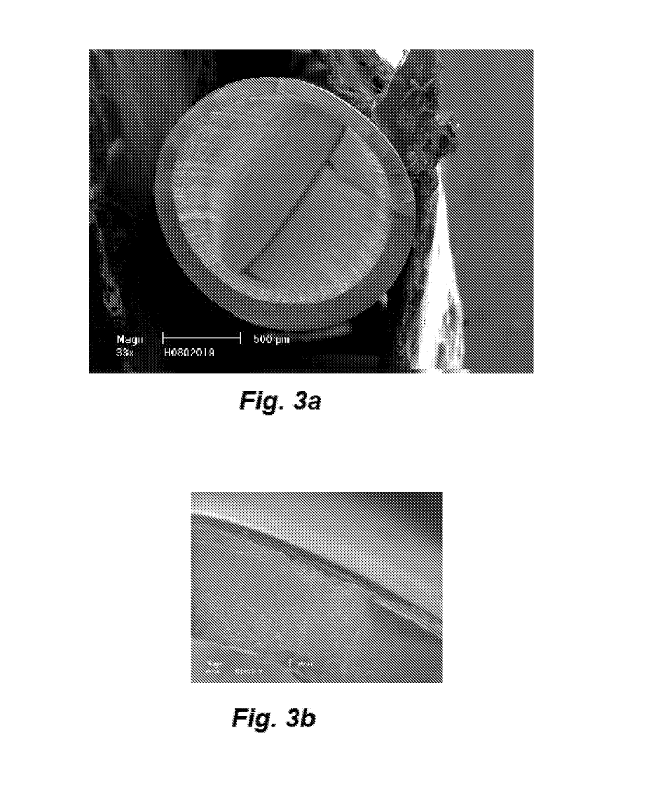

The structure of a polymeric hollow fiber prepared from ethylene-chlorotrifluoroethylene copolymer according to methods of the present disclosure may be seen in the cross-section SEM image shown in FIG. 3a and FIG. 3b. These images show a dense, uniform structure throughout the fiber wall, thus allowing heat transfer only with no mass (liquid) transfer. The hollow fiber prepared in this Example has a wall thickness of approximately 150 μm. Because a dense surface structure may be designed to prevent mass transfer through the membrane pores, the surface porosity of the fibers of the present disclosure may be kept to at most about 15 percent porosity.

### Example 2

The surface porosity of the fiber of Example 1 was tested with a water permeability testing device.

Water was initially driven by force through the fiber under pressure of approximately 100 to 400 kPa. When no water was found to pass through the membrane fiber wall, the hydrophobic fibers were pre-wet with ethanol to result in a temporary hydrophilic fiber and the pressure test was repeated. Again, no water was found to pass through the membrane fiber wall. During the heat transfer/heat exchange process, the levels of cold and hot fluid were carefully monitored. It was noted that no change in volume occurred on either side, indicating no loss/transfer of fluid. Thus, the experimental results confirmed a very low surface porosity.

### Example 3

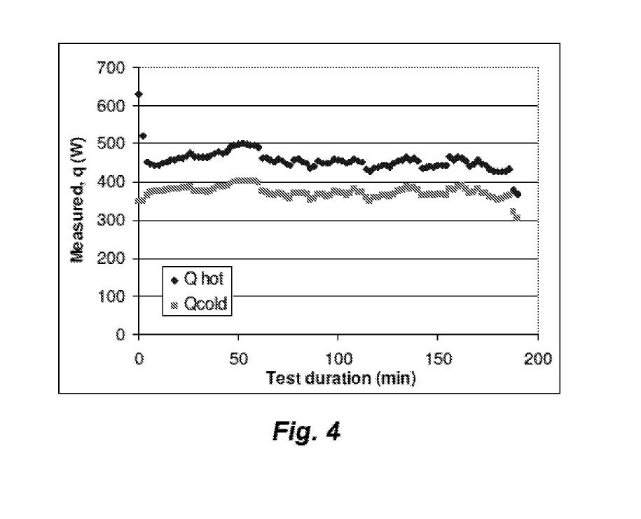

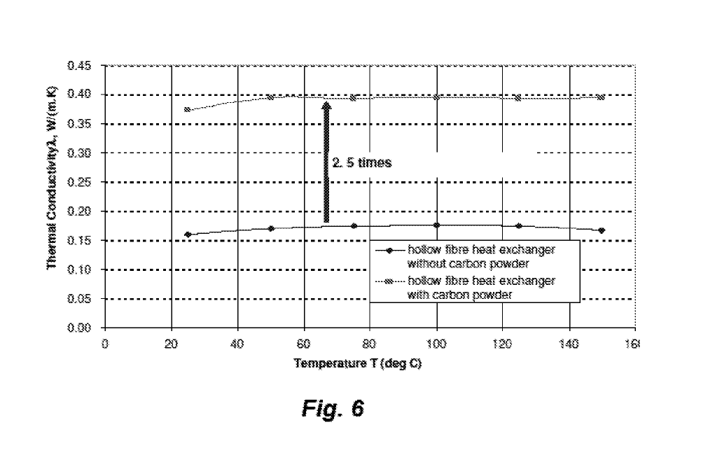

FIGS. 4 and 6 show performance data of composite hollow fibers prepared according to certain embodiments of the disclosure. The fibers prepared from a dope have a total solids concentration of about 35 weight percent. The total solids of this dope include 80 weight percent ethylene-chlorotrifluoroethylene and 20 weight percent nano-carbon powder.

FIG. 4 illustrates that an average heat transfer rate [q(W)] of about 400 W may be achieved with the fibers. The tested overall heat transfer coefficient range is from 80 to 95 W/m²/K. The data presented in FIG. 4 represents the overall heat flux across the heat exchanger fiber walls by means of thermal conduction from hot to cold fluid. The experiment was carried out for at least 3 hours (180 min) to monitor the stability and performance of heat exchanger. As shown in FIG. 4, the performance of the heat exchanges was stable over the entire time period tested.

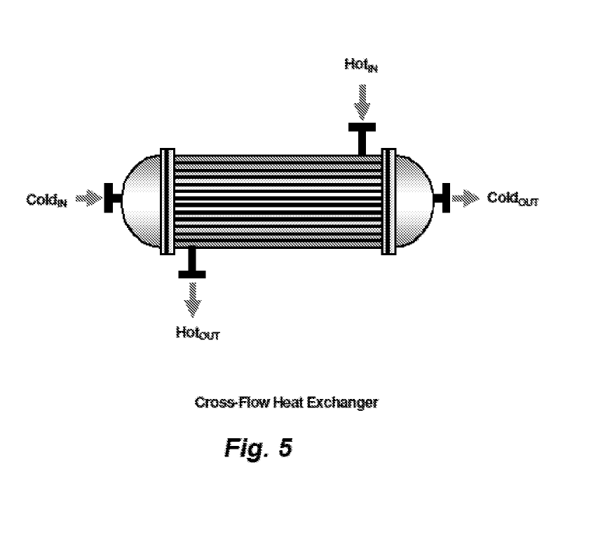

The laboratory tests were conducted using “mini-modules” designed according to a shell-and-tube cross-flow heat exchanger, as shown in FIG. 5. Experimental parameters of the “mini-modules” for laboratory-scale heat exchanger performance tests include a cold fluid flow rate of 6.4 g/sec and a hot fluid flow rate of 42.11 g/sec. Ten heat exchanger fibers were used in this example. The total available area for heat transfer on the hot side (shell) of the module was 0.105 m². The total available area for heat transfer on the cold side (lumen) of the module was 0.08 m². The laboratory tests were conducted using “mini-modules” designed according to a shell-and-tube cross-flow heat exchanger, as shown in FIG. 5.

The amount of heat transferred through the hollow fiber tube was calculated as follows:

Q=m·Cₚ·ΔT

Q=heat conducted through the hollow fiber heat exchanger (W)

m=flow rate of the fluid (kg/hr)

Cₚ=specific heat capacity (kJ/kg) at operating temperatures

ΔT=temperature difference across the module, ° K=(T_{hot fluid}−T_{cold fluid})

The experimental results depicted in FIG. 4 were generated using cold tap water, which was allowed to flow through the lumen side of the fibers in the mini-module, while the hot water (preheated at elevated temperature to a predetermined temperature) was allowed to flow through the shell side. Alternatively, it is possible for hot fluid to pass through the lumen of the fiber and cold fluid to pass through the shell side.

FIG. 6 shows the thermal conductivity for a hollow fiber heat exchanger with a carbon powder filler compared to one without any filler. In an exemplary embodiment, the continuous surface structure combined with the dense wall structure, along with the inclusion of the nano-carbon powder to improve the thermal conductivity of the polymer of the fiber was achieved. The fibers exchanged heat about 2.5 times more readily than a comparison fiber made from the same dope and using the same method without the carbon filler. As shown in FIG. 6, the thermal conductivity of the hollow fiber heat exchanger without carbon powder was between about 0.15 W/m·K and 0.20 W/m·K, while the thermal conductivity of the hollow fiber heat exchanger with carbon was about 0.4 W/m·K.

The fibers of the disclosure may be amenable to bundling and potting into modules, which may enable a very large number of parallelized fibers at high packing densities to act in concert. In modules, the lumens of the fibers form a first region of fluid communication, while the outer walls are in a second region of fluid communication. The fluid at a first temperature may thus be run through the lumens of a number of parallel fibers, while the fluid at a second temperature may be contacted with the outside of the fiber wall.

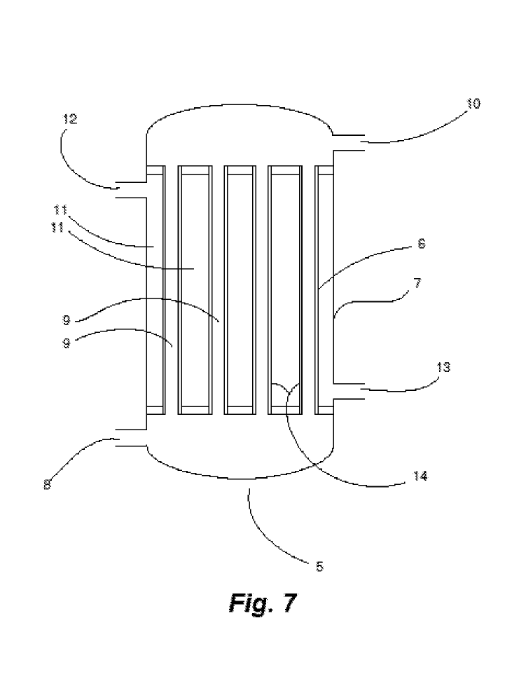

To illustrate, FIG. 7 shows a heat exchanger 5 formed from a number of hollow fibers 6 potted into a module 7. Hot water enters the exchanger 5 through manifold 8. The hot water then passes through the lumens 9 of the fibers 6 and moves to exit manifold 10. At the same time, cold water enters shell 11 surrounding the fibers 6 via entry port 12 and moves to exit port 13. As the hot water moves through the lumens 9 of the fibers 6, heat exchange takes place across the membrane wall 14. The originally hot water entering at 8 is cooled by the time it exits the lumens into manifold 10. Conversely, the water in the shell side exits at exit port 13 at a temperature greater than its entry temperature at entry port 12.

While exemplary embodiments of the disclosure have been disclosed many modifications, additions, and deletions may be made therein without departing from the spirit and scope of the disclosure and its equivalents, as set forth in the following claims.

Those skilled in the art would readily appreciate that the various parameters and configurations described herein are meant to be exemplary and that actual parameters and configurations will depend upon the specific application for which the membranes and methods of the present disclosure are used. Those skilled in the art will recognize, or be able to ascertain using no more than routine experimentation, many equivalents to the specific embodiments described herein. For example, those skilled in the art may recognize that the system, and components thereof, according to the present disclosure may further comprise a network of systems or be a component of a heat exchanger system or water treatment system. It is, therefore, to be understood that the foregoing embodiments are presented by way of example only and that, within the scope of the appended claims and equivalents thereto, the disclosed membranes, heat exchanger systems and methods may be practiced otherwise than as specifically described. For example, flat sheet membranes may be prepared and used in the systems of the present disclosure. The present membranes, heat exchanger systems, and methods are directed to each individual feature, membrane, system, or method described herein. In addition, any combination of two or more such features, systems or methods, if such features, systems or methods are not mutually inconsistent, is included within the scope of the present disclosure.

Further, it is to be appreciated various alterations, modifications, and improvements will readily occur to those skilled in the art. Such alterations, modifications, and improvements are intended to be part of this disclosure, and are intended to be within the spirit and scope of the disclosure. For example, the membranes of the present disclosure may be prepared by any membrane preparation technique, including thermally induced phase separation or diffusion induced phase separation techniques. In other instances, an existing facility may be modified to utilize or incorporate any one or more aspects of the invention. Thus, in some cases, the systems may involve connecting or configuring an existing facility to comprise a heat exchanger system. Accordingly, the foregoing description and drawings are by way of example only. Further, the depictions in the drawings do not limit the disclosures to the particularly illustrated representations.

Use of ordinal terms such as “first,” “second,” “third,” and the like in the specification and claims to modify an element does not by itself connote any priority, precedence, or order of one element over another or the temporal order in which acts of a method are performed, but are used merely as labels to distinguish one element having a certain name from another element having a same name, but for use of the ordinal term, to distinguish the elements.

What is claimed is:

1. A polymeric membrane comprising:
a polymeric material; and
a thermally conductive filler dispersed in the polymeric material, the polymeric membrane having a thickness in a range of about 50 microns to about 350 microns and a porosity of up to about 15 percent.

2. The polymeric membrane of claim 1, wherein the thickness of the polymeric membrane is in a range of about 100 microns to about 250 microns.

3. The polymeric membrane of claim 1, wherein the polymeric material is hydrophobic.

4. The polymeric membrane of claim 1, wherein the thermally conductive filler is in a powder form.

5. The polymeric membrane of claim 1, wherein the thermally conductive filler is selected from the group consisting of zinc oxide, titanium dioxide, carbon powder, nano-carbon powder, aluminium nitride, silicon carbide, boron nitride, and combinations thereof.

6. The polymeric membrane of claim 5, wherein the thermally conductive filler is nano-carbon powder.

7. The polymeric membrane of claim 1, wherein the polymeric membrane is a hollow fiber membrane.

8. The polymeric membrane of claim 7, wherein the membrane has an outer diameter in a range of about 0.5 mm to about 2.0 mm.

9. The polymeric membrane of claim 8, wherein the membrane has an outer diameter in a range of about 1.0 mm to about 1.5 mm.

10. The polymeric membrane of claim 1, wherein the polymeric material is selected from the group consisting of polyvinylidene fluoride, poly(ethylene chlorotrifluoroethylene), ethylene trifluoroethylene, polytetrafluoroethylene, fluorinated ethylene propylene, and combinations thereof.

11. The polymeric membrane of claim 1, wherein the polymeric material is at least one of poly(ethylene chlorotrifluoroethylene) and polyvinylidene fluoride.

12. The polymeric membrane of claim 1, wherein the polymeric membrane has a heat to transfer coefficient of about 80 W/m²/K to about 95 W/m²/K.

13. A method of making a thermally conductive polymeric hollow fiber membrane comprising:
preparing a polymer solution comprising a polymeric material and a solvent for the polymeric material at a predetermined temperature;
introducing a thermally conductive filler to the polymer solution to form a dope;
extruding the dope to form the thermally conductive polymeric hollow fiber membrane by
contacting an external surface of the dope with a coating fluid;
contacting an internal lumen surface of the dope with a lumen forming fluid; and
inducing a phase separation in the dope to form the thermally conductive polymeric hollow fiber membrane.

14. The method of claim 13, wherein the dope comprises a total solids content comprising the polymeric material and the thermally conductive filler.

15. The method of claim 14, wherein the total solids content of the dope is in a range of about 20 percent to about 50 percent by weight.

16. The method of claim 15, wherein the total solids content of the dope is in a range of about 30 percent to about 35 percent by weight.

17. The method of claim 16, wherein the total solids content comprises the polymeric material in an amount in a range of about 70 percent to about 95 percent.

18. The method of claim 13, wherein the predetermined temperature is greater than about 200° C.

19. The method of claim 18, wherein the predetermined temperature is about 220° C.

20. The method of claim 14, wherein the lumen forming fluid is diethylene glycol.

21. The method of claim 14, further comprising controlling a flow rate of the lumen forming fluid to form the polymeric hollow fiber membrane.

22. The method of claim 14, further comprising controlling a flow rate of the coating fluid to form the polymeric hollow fiber membrane.

23. A heat exchanger system comprising:
a membrane module comprising a plurality of hollow fiber polymeric membranes, the plurality of hollow fiber polymeric membranes comprising a polymeric material and a thermally conductive filler dispersed in the polymeric membrane, the polymeric membrane having a porosity of up to about 15 percent;
a first manifold fluidly connecting a source of a first fluid to at least one lumen of the plurality of hollow fiber polymeric membranes;
a second manifold fluidly connecting a source of a second fluid to a shell surrounding the plurality of hollow fiber membranes;
a first exit port fluidly connected to the source of the first fluid; and
a second exit port fluidly connected to the source of the second fluid.
